(19) United States
(12) Patent Application Publication
(10) Pub. No.: US 2014/0026297 A1
(43) Pub. Date: Jan. 30, 2014

(54) Fishing Accessory or Garment

(71) Applicant: Maria E. Enes, Mount Vernon, NY (US)

(72) Inventor: Maria E. Enes, Mount Vernon, NY (US)

(73) Assignee: Maria E. Enes, Mount Vernon, NY (US)

(21) Appl. No.: 13/556,770

(22) Filed: Jul. 24, 2012

(51) Int. Cl. A01K 97/00; A41D 27/08

(52) U.S. Cl. CPC A01K 97/00; A41D 27/08
USPC 2/410; 2/244; 2/209.13; 2/102; 2/69; 2/93; 2/311; 2/227; 43/4.5

(57) ABSTRACT

The present invention discloses a garment or accessory worn for fishing that comprises a magnet of sufficient size and strength to hold fishing hooks or lures.

### REFERENCES CITED

References Cited:

| | | | |
|---|---|---|---|
| 3,680,750 | August 1972 | Franco | 224/5 G |
| 5,505,354 | April 1996 | Hutton et al | 224/196 |
| 5,526,927 | June 1996 | McLemore | 206/315.11 |
| 6,516,555 | February 2003 | Buzzell | 43/57.1 |
| 7,299,583 | November 2007 | Adams | 43/25.2 |
| 7,997,024 | August 2011 | Gesik | 43/57.1 |
| 2007/0214702 | September 2007 | Christiansen | 43/11 |
| 2007/0220801 | September 2007 | Clawson | 43.54.1 |
| 2008/0164267 | July 2008 | Huber | 220/660 |
| 2011/0005121 | January 2011 | Gelber | 43/57.1 |
| 2012/0055962 | March 2012 | Lee et al. | 224/191 |

### BACKGROUND

Fishing is an extremely popular recreational activity in the United States due in no small part to the ability of persons of all ages to participate. Over the last ten years or so, fly fishing has exploded in popularity. Fly fishing usually, although not always, involves floating an artificial fly on the surface of a body of water as opposed to allowing the bait to sink a depth beneath a water's surface. Accordingly, tackle having a high density, such as swivels and sinkers, are avoided as they tend to cause the line and bait to sink. Further, swivels and the like tend to create a visual distraction for a fish that can hinder the fisherman's ability through the presentation and working of a fly to convince the fish that the fly is real and worthy of consumption. Accordingly, various sections of fishing line are typically knotted or tied together.

A typical fly fishing rod setup includes three different types of fishing line: the main line, which comprises a relatively thick and heavy floating or sinking line; a monofilament leader, which is often tapered along its length; and a monofilament tippet. The main line provides the heft and stiffness necessary for a fly fisherman to whip the line back and forth during casting. The leader, typically about 9 feet or so in length provides for transition and separation between the stiff thick main line and the usually svelte fly. The leader is thicker where it connects with the main line and thinnest at its distal end. The stiffer and thicker portion helps facilitate better casting; whereas, the thinner more flexible portion permits the fly to move in the water with a more natural appearance. A tippet of 12-24′ is typically tied to the distal and thin end of the leader and is usually relatively thin. Tippet is largely sacrificial allowing a fisherman to quickly cut the line to remove one fly and replace it with another. When the tippet becomes too short or a heavier weight tippet is required for larger fish, the fisherman need only cut off a small portion of the more costly tapered leader to remove the tippet.

Trout and other types of fish caught by fly fishing can be fickle. One day they may be interested in one type of fly; whereas, on another day they may be interested in another type of fly altogether. Determining what fly to use on a particular day under particular conditions is often an exercise in trial and error. Changing out a fly comprises cutting the tippet near the fly; holding the thin nearly invisible monofilament tippet while storing the removed fly and retrieving a replacement fly; and finally tying the replacement fly to the tippet. Often during the process of storing the one fly and retrieving the other, the fisherman, trying to manage three items with two hands, will hook one of the flies or lures into the fabric of his or her fishing vest or hat. Doing so introduces the hazard of cutting the fisherman's skin with the hook and with it the potential for infection. At the least, repeatedly hooking the fabric of the fishing garment will cause it to cut, tear, and degrade over time.

The prior art describes several known uses of magnets in conjunction with fishing tackle.

Franco teaches in U.S. Pat. No. 3,680,750 a fly fishing case that can be attached to the clothing of a fisherman. The case contains two magnets to hold the flies. The two magnets are attracted to one another and help keep the case closed. The present invention does not require a case.

In U.S. Pat. No. 5,505,354 Hutton et al teach a wearable bait and tackle box that attaches to a fisherman's belt. The box contains a removable partition that comprises a magnet. The present invention does not require a box or a removable partition.

McLemore teaches in U.S. Pat. No. 5,526,927 a tackle box comprising a case having a magnetically attractive panel. The present invention does not require a case or a panel.

In U.S. Pat. No. 6,516,555 Buzzell teaches a tackle box in which the fly fishing lures are secures to the holder by magnetic means. The securing magnets are vertically mounted into slots in the tackle box. The present invention does not require a box nor is the magnet mounted in slots.

Adams teaches in U.S. Pat. No. 7,299,583 a fishing hook retaining apparatus comprising a sleeve, which is integral to the shaft of a fishing pole, having a magnet secured in the interior of the sleeve. The present invention does not require a sleeve, is not integral to the fishing pole shaft, and does not secure a magnet inside a sleeve.

In U.S. Pat. No. 7,997,024 Gesik teaches a magnetic fishing lure holder. The holder apparatus is attached to a vertical surface of a fishing boat hull, console, or seat. It includes an elongated frame, first and second flanges, and magnetic holders positioned in the horizontal flange. The present invention is attached to a garment and worn by the fisherman, not attached to a boat hull. It also does not require a frame or flanges.

Christiansen teaches in U.S. Pat. Appl. No. 2007/0214702 a fishing garment system and method wherein a landing net may be removably secured to the back of the garment. The landing net is secured by a connector system. “One example of a connector system comprises at least one magnet that is coupled to the handle near where the handle reaches the loop. Another example is a first pair of magnets positioned on opposite sides of the mesh, and a second pair of magnets configured to be placed on opposite sides of a user's garment.” (page 1, 0005) “In other embodiments, the first connection system may comprise a first and a second magnet, one magnet and a metal plate to which the magnet is attracted, or a first and a second hook and loop fastener (e.g. Velcro® tape), one of which is attached to the back panel of the garment and the other of which is attached to the landing net handle.” (page 1, 0009) In the present invention only a single magnet is used, the magnet is attached or incorporated into the garment, and no metal plate is required.

In U.S. Pat. Appl. No. 2007/0220801 Clawson teaches a fishing lure holder comprising a cylindrical post to which fishing lures are attached, wherein the cylindrical post is attached to the lid of a clear plastic bottle. Magnets are attached to the free end of the post and to the outside of the lid or the bottom of the bottle. The present invention does not require a post, bottle, or lid.

Huber teaches in U.S. Pat. Appl. No. 2008/0164267 a holder apparatus for a portable device. Two magnets are attached to one surface of the holder. Two magnets are also attached to the surface of a substrate so that their magnetic polarities correspond to the opposite magnetic poles of the magnets on the holder and therefore will hold the holder in a preferred alignment. Huber includes fishing lures among the portable devices that can be held in the holder apparatus. The present invention does not require a holder apparatus and uses a single magnet.

In U.S. Pat. Appl. No. 2011/0005121 Gelber teaches a fishing lure neodymium magnetized holder including an array of neodymium magnets attached to a flat sheet of iron or steel. The flat sheet is sealed in a moisture proof material and may have suction cups that allow it to be placed on a smooth surface in a fishing boat. The present invention does not require a flat sheet of iron or steel and uses only a single magnet, the magnet being attached or incorporated into the garment.

Lee et al teach in U.S. Pat. Appl. No. 2012/0055962 a user wearable line holder. In some embodiments the line holder may be attached to a piece of clothing by a pair of magnets, with the line holder being molded over the first magnet and held in place by the second magnet positioned behind the fisherman's shirt or other piece of clothing. The line holder is made from a button of resilient elastomeric polymeric material that is about 1 cm thick. These materials typically exhibit low magnetic permeability. Lee also teaches that the user may “ temporarily place the fly on the holder wherein the magnets will hold it in place while he finishes changing the bait.” The present invention requires only a single magnet with no button of polymeric material molded onto the magnet.

A need exists for a better means of holding fishing hooks, flies, and lures.

### BRIEF DESCRIPTION OF THE DRAWINGS

FIG. 1 shows a fishing vest 1 onto which a magnet 2 has been attached.

FIG. 2 shows a fishing hat 3 onto which two magnets 4 have been attached.

FIG. 3 shows a baseball hat 5 onto which two magnets 6 have been attached.

FIG. 4 shows a magnet 7 which has been sewn into the layers of a fishing vest 8

FIG. 5 shows a magnet 9 which is attached to a pin 10 and a pin-back 11

FIG. 6 shows a magnet 12 which is attached to a piece of Velcro showing the hooks 13a and loops 13b sides of the Velcro.

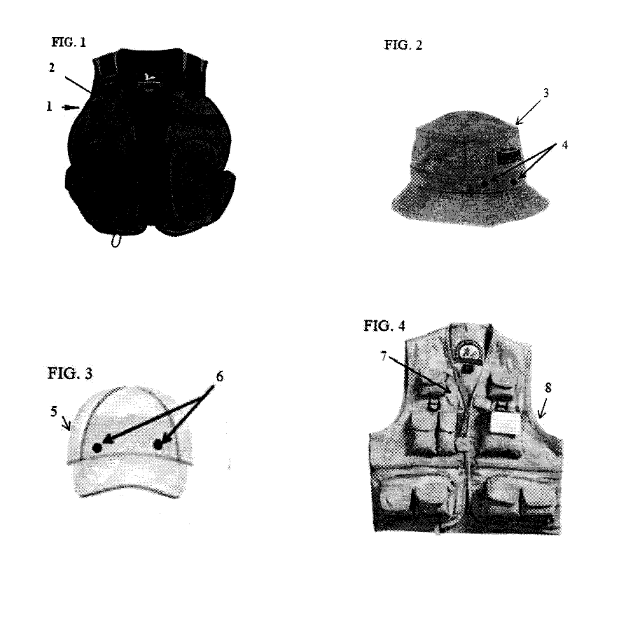

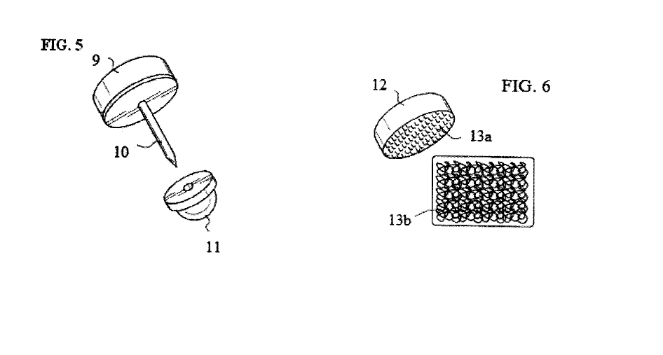

### TERMINOLOGY

The terms and phrases as indicated in quotation marks (” “) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied and as such where the indicated margins are not readily applicable, the foregoing terms have meanings attributable to them as would be understood by someone of ordinary skill in the art given the benefit of this disclosure.

As used in this specification and the appended claims, “magnetic” refers to one of: (i) a magnet comprised of any suitable material including but not limited to rare earth magnets; and (ii) a ferritic material.

As used in the specification and the appended claims, “Pull Strength” is defined as the force required to pull a magnet free from a flat steel plate using force perpendicular to the surface. Pull force is equivalent to Breakaway Force as defined in STANDARD MDFA 101 95, “TEST METHOD FOR DETERMINING BREAKAWAY FORCE OF A MAGNET” by the Magnet Distributors and Fabricators Association, 11 S. LaSalle Street, Chicago, Ill. 60603

As used herein, the term “fabric” refers to any substantially flexible sheet material. Fabric can comprise woven or unwoven fibers with or without additional coatings applied thereto.

### DETAILED DESCRIPTION

The present invention comprises a magnet that can be either removably or permanently attached to a piece of clothing used in fishing, such as a shirt, vest, or hat. The magnet allows the user to temporarily secure items such as hooks, lures, and flies within easy reach. In one preferred use, the embodiments permit a fisherman wearing a piece of clothing having the holder attached thereto to temporarily store a hook, lure, or fly on the holder while he/she is making changes to his/her fishing bait. The holder relieves the fisherman from holding and keeping of track a fishing hook, lure, or fly while performing tasks such as changing flies or other bait and tackle.

The magnet should be of sufficient size and strength to secure the object it is intended to hold. The magnet should be not smaller than 2 mm in length, width or diameter, preferably from 3mm to 300 mm, more preferably from 4 mm to 100 mm, and most preferably from 6 mm to 30 mm. The thickness of the magnet should be greater than 0.1 mm, preferably from 0.5 mm to 20 mm, more preferably from 1 mm to 10 mm, and most preferably from 1 mm to 6 mm. The magnet can be any plan shape including circular, oval, square, rectangular, polygonal, and irregular, and may be solid or have holes. The shape of the magnet may correspond to letters, numbers, or groups of letters or numbers, or may correspond to a logo, message, or slogan.

The pull strength of the magnet should be sufficient to secure the object it is intended to hold. The pull strength should be greater than 10 grams, preferably from 50 grams to 5 kg, more preferably from 100 grams to 3 kg, and most preferably from 500 grams to 3 kg.

Among the pieces of clothing that are commonly used in fishing are hats, including but not limited to Boonie hats, baseball caps, and hardhats, vests, life vests, shirts, including but not limited to T-shirts, polo shirts, sweatshirts, pullovers, sweaters, jackets, windbreakers, belts, suspenders, and pants.

In one embodiment, the magnet is attached to the piece of clothing by such means as an adhesive, Velcro, or with a pin and pin-back. The adhesive can include but is not limited to a hot melt adhesive, and acrylic or silicone adhesive, a rubber cement, or a cyano-acrylate. The magnet can be attached by the garment manufacturer or can be attached by the user. In another embodiment the magnet can be sewn into the piece of clothing so that the magnet is not visible. In another embodiment the magnet can be attached to a plastic sleeve into which a fishing license or permit can be inserted. The sleeve is then pinned to the piece of clothing.

The magnet can be attached to the garment by mechanical means such as a pin and pin-back, a safety pin, a clip, Velcro, or a hook and loop type fastener.

In other embodiments the present invention can be used to hold fishing tools such as hook(s), Lures, Jig's, Ball Bearing Swivels, Snaps Swivels, Hook Removers, and Lighters. In other embodiments the present invention can be used to hold archery tools such as Fieldtrip(s), Brodhead's, and Bow Releases. In other embodiments the present invention can be used to hold tools that include one or more parts, scissors, saws, hammers, wrenches, screws, screw drivers, bolts, nuts, washers, fasteners, hinges, flash light, rulers, tape measurers, and other mechanical parts, or tools or components that may be used to perform mechanical work. Further examples of instruments, devices or hardware which could be positioned on embodiments of the claimed subject matter include keys, pens, batteries, needles, tweezers, paper clips, hair clips, pins, bullets, razor blades, and staples.

Magnet

A magnet is an object that has a magnetic field. It can be in the form of a permanent magnet or an electromagnet. Permanent magnets do not rely upon outside forces to generate their field while electromagnets rely upon electric current to generate a magnetic field so that when an current increases, so does the field.

Magnets are attracted to, or repelled by, other materials. A material that is strongly attracted to a magnet is said to have a high permeability. Examples of materials with very high permeability include iron and steel. Other materials, such as wood, fabric, and most polymers exhibit low permeability. For example, polyolefins, polyurethanes, polyvinylchloride (PVC), ethylenevinylacetate (EVA), polycarbonate, ionomers, and polystyrene all have low permeability. These material acts as spacers, reducing the strength of the magnet as a function of the square of the thickness. In the present invention it is therefore necessary to minimize the thickness of any materials that come between the magnet and the object it is intended to hold. Preferably the thickness of any material covering the magnet is no greater than 6 mm, more preferably no greater than 2 mm, even more preferably no greater than 1 mm, and most preferably no greater than 0.5 mm. In one embodiment the magnet is in direct contact with the object it is intended to hold. In another embodiment the magnet may be coated with a layer of paint or decorated with a logo, the thickness of these layers being no greater than 1 mm. In another embodiment the magnet may be covered with a layer of fabric or sewn into a garment in which the thickness of the fabric is no greater than 1 mm thick.

A permanent magnet is an object made from a material that is magnetized and creates its own persistent magnetic field. Materials that can be magnetized, which are also the ones that are strongly attracted to a magnet, are called ferromagnetic (or ferrimagnetic). These include iron, nickel, cobalt, some alloys of rare earth metals, and some naturally occurring minerals such as lodestone. Although ferromagnetic (and ferrimagnetic) materials are the only ones attracted to a magnet strongly enough to be commonly considered magnetic, all other substances respond weakly to a magnetic field, by one of several other types of magnetism.

Ferromagnetic materials can be divided into magnetically “soft” materials like annealed iron, which can be magnetized but do not tend to stay magnetized, and magnetically “hard” materials, which do. Permanent magnets are made from “hard” ferromagnetic materials such as alnico and ferrite that are subjected to special processing in a powerful magnetic field during manufacture, to align their internal microcrystalline structure, making them very hard to demagnetize. To demagnetize a saturated magnet, a certain magnetic field must be applied, and this threshold depends on coercivity of the respective material. “Hard” materials have high coercivity, whereas “soft” materials have low coercivity.

An electromagnet is made from a coil of wire that acts as a magnet when an electric current passes through it but stops being a magnet when the current stops. Often, the coil is wrapped around a core of ferromagnetic material like steel, which enhances the magnetic field produced by the coil.

The overall strength of a magnet is measured by its magnetic moment or, alternatively, the total magnetic flux it produces. The local strength of magnetism in a material is measured by its magnetization.

Ceramic or Ferrite

Ceramic, or ferrite, magnets are made of a sintered composite of powdered iron oxide and barium/strontium carbonate ceramic. Given the low cost of the materials and manufacturing methods, inexpensive magnets (or non-magnetized ferromagnetic cores, for use in electronic components such as radio antennas, for example) of various shapes can be easily mass-produced. The resulting magnets are non-corroding but brittle and must be treated like other ceramics.

Alnico

Alnico magnets are made by casting or sintering a combination of aluminum, nickel and cobalt with iron and small amounts of other elements added to enhance the properties of the magnet. Sintering offers superior mechanical characteristics, whereas casting delivers higher magnetic fields and allows for the design of intricate shapes. Alnico magnets resist corrosion and have physical properties more forgiving than ferrite, but not quite as desirable as a metal. Trade names for alloys in this family include: Alni, Alcomax, Hycomax, Columax, and Ticonal.^{[23]}

Injection-Molded

Injection-molded magnets are a composite of various types of resin and magnetic powders, allowing parts of complex shapes to be manufactured by injection molding. The physical and magnetic properties of the product depend on the raw materials, but are generally lower in magnetic strength and resemble plastics in their physical properties.

Other types of magnets include plastic magnets which are non-metallic magnets made from the polymer PANiCNQ, which is a combination of emeraldine-based polyaniline (PANi) and tetracyanoquinodimethane (TCNQ). This type of magnet is a conductive polymer.

Flexible

Flexible magnets are similar to injection-molded magnets, using a flexible resin or binder such as vinyl, and produced in flat strips, shapes or sheets. These magnets are lower in magnetic strength but can be very flexible, depending on the binder used. Flexible magnets can be used in industrial printers.

Rare-Earth Magnets

Neodymium magnets or NIB magnets also known in the prior art as rare-earth magnets or “neo” magnets are low cost, powerful magnets made of a combination of neodymium, iron, and boron—Nd₂Fe₁₄B. These magnets are very strong in comparison to their mass so they can be used to hold much larger items in place. Another type of rare earth magnet is a Samarium-cobalt magnets (SmCo5) magnet, composed of samarium and cobalt.

Single-Molecule Magnets (SMMs) and Single-Chain Magnets (SCMs)

In the 1990s, it was discovered that certain molecules containing paramagnetic metal ions are capable of storing a magnetic moment at very low temperatures. These are very different from conventional magnets that store information at a magnetic domain level and theoretically could provide a far denser storage medium than conventional magnets. In this direction, research on monolayers of SMMs is currently under way. Very briefly, the two main attributes of an SMM are:
1. a large ground state spin value (S), which is provided by ferromagnetic or ferrimagnetic coupling between the paramagnetic metal centres
2. a negative value of the anisotropy of the zero field splitting (D)

Most SMMs contain manganese but can also be found with vanadium, iron, nickel and cobalt clusters. More recently, it has been found that some chain systems can also display a magnetization that persists for long times at higher temperatures. These systems have been called single-chain magnets.

Electromagnet

An electromagnet is a magnet that runs on electricity. Unlike a permanent magnet, the strength of an electromagnet can easily be changed by changing the amount of electric current that flows through it. The poles of an electromagnet can even be reversed by reversing the flow of electricity.

If a wire carrying an electric current is formed into a series of loops, the magnetic field can be concentrated within the loops. The magnetic field can be strengthened even more by wrapping the wire around a core. The atoms of certain materials, such as iron, nickel and cobalt, each behave like tiny magnets. Normally, the atoms in something like a lump of iron point in random directions and the individual magnetic fields tend to cancel each other out. However, the magnetic field produced by the wire wrapped around the core can force some of the atoms within the core to point in one direction. All of their little magnetic fields add together, creating a stronger magnetic field.

As the current flowing around the core increases, the number of aligned atoms increases and the stronger the magnetic field becomes. At least, up to a point. Sooner or later, all of the atoms that can be aligned will be aligned. At this point, the magnet is said to be saturated and increasing the electric current flowing around the core no longer affects the magnetization of the core itself.

Table 1 below consists of magnets that are suitable for the present invention. These magnets are commercially available from Applied Magnets of Plano, Tex.

TABLE 1

| | | Pull Strength | Pull Through |
|---|---|---|---|
| Magnet Type | Diameter × Thickness (in) | (lbs) | (in) |
| N48 | 3/16 × 1/16 | 1.2 | 1/16 |
| N52 | 3/16 × 1/16 | 1.8 | 1/16 |
| N42 | ¼ × 1/16 | 1.6 | 1/16 |
| N48 | ¼ × 1/16 | 1.8 | 1/16 |
| N42 | ¼ × 1/10 | 2.4 | 1/10 |
| N42 | ¼ × ⅛ | 3.3 | ⅛ |
| N50 | ¼ × ⅛ | 3.9 | ⅛ |
| N42 | ¼ × ¼ | 5.5 | ¼ |
| N40 | ¼ × ¼ | 5.1 | ¼ |
| N48 | ¼ × ¼ | 6.3 | ¼ |
| N42 | ¼ × ¼ | 5.0 | ¼ |
| N42 | ⅜ × 1/16 | 2.2 | 1/16 |
| N50 | ⅜ × 1/16 | 2.6 | 1/16 |
| N45 | ⅜ × 1/16 | 3.0 | 1/16 |
| N42 | ⅜ × 1/10 | 3.8 | 1/10 |
| N45 | ⅜ × 1/10 | 4.0 | 1/10 |
| N42 | ⅜ × ⅛ | 5.5 | ⅛ |
| N45 | ⅜ × ⅛ | 6.0 | ⅛ |
| N52 | ⅜ × ⅛ | 6.9 | ⅛ |
| N42 | ½ × 1/16 | 3.0 | 1/16 |
| N45 | ½ × 1/16 | 3.2 | 1/16 |
| ND030-1 | ½ × 1/10 | 5.2 | 1/10 |
| ND031 | ½ × ⅛ | 6.6 | ⅛ |
| ND030-1 | ½ × ⅛ | 7.0 | ⅛ |
| N45 | ⅝ × 1/16 | 4.0 | 1/16 |
| N42 | ⅝ × ⅛ | 8.0 | ⅛ |
| N45 | ⅝ × 1/32 | 2.0 | 1/32 |
| N42 | ¾ × 1/32 | 2.3 | 1/32 |
| N45 | ¾ × 1/10 | 7.7 | 1/10 |
| N45 | ¾ × 1/16 | 5.0 | 1/16 |

### EXAMPLES

### Example 1

A magnet was attached to a fishing vest by hot melt adhesive at the left shoulder strap. The magnet was a type N42, ¾× 1/32 inch, with a pull strength of 2.3 lbs.

### Example 2

A magnet was sewn into a fishing vest at the left shoulder strap. The magnet was a type N40, ¼×¼ inch, with a pull strength of 5.1 lbs.

### Example 3

A magnet was attached to a fishing hat by a pin and bin-back. The magnet was a type N45, ¾ 1/16 inch, with a pull strength of 5.0 lbs. The magnet was printed with a logo.

### Example 4

A flexible magnet was attached to a fishing vest by hot melt adhesive adjacent to the vest zipper flap. The magnet was 5 inches long, ½ inch wide, and 1/16 in thick. The magnet had a paint layer.

### Example 5

A flexible magnet was attached to a fishing vest by a piece of Velcro. The magnet was 3 inches long, 2 inches wide, and 1/16 in thick and was shaped to form the words “World's Best Fisherman”. The magnet had a paint layer.

### Example 6

A magnet was attached to a pair of suspenders by a pin and bin-back. The magnet was a type N45, ¾× 1/16 inch, with a pull strength of 5.0 lbs. The magnet was printed with a logo.

While this invention has been described as having a preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

What is claimed is:

1. A fishing accessory comprising a magnet and a means of attaching said magnet to a fishing garment.

2. The fishing accessory of claim 1 wherein the magnet is selected from the group consisting of permanent magnets, ferromagnets, alnico magnets, rare earth magnets, injection molded magnets, flexible magnets, ceramic magnets, and electromagnets.

3. The fishing accessory of claim 1 wherein the means of attaching said magnet is by an adhesive or by a mechanical means.

4. The fishing accessory of claim 1 wherein the pull strength of the magnet is not less than 50 grams to not more than 3 kg.

5. The fishing accessory of claim 1 wherein the size of the magnet is not less than 2 mm in diameter.

6. The fishing accessory of claim 1 wherein the shape of the magnet is circular, oval, square, rectangular, polygonal, or irregular.

7. The fishing accessory of claim 6 wherein the shape of the magnet corresponds to letters, numbers, or groups of letters or numbers, or a logo, message, or slogan.

8. The fishing accessory of claim 1 wherein the surface of the magnet is covered with a layer of material no greater than 1 mm thick.

9. The fishing accessory of claim 1 wherein the garment is selected from the group consisting of Boonie hats, baseball caps, and hardhats, vests, life vests, shirts, T-shirts, polo shirts, sweatshirts, pullovers, sweaters, jackets, windbreakers, belts, suspenders, and pants.

10. A fishing garment comprising a magnet and a means of attaching the magnet.

11. The fishing garment of claim 10 wherein the magnet is selected from the group consisting of permanent magnets, ferromagnets, alnico magnets, rare earth magnets, injection molded magnets, flexible magnets, ceramic magnets, and electromagnets.

12. The fishing garment of claim 10 wherein the means of attaching the magnet is by an adhesive, by a mechanical means, or by sewing the magnet into the garment.

13. The fishing garment of claim 10 wherein the pull strength of the magnet is not less than 50 grams to not more than 3 kg.

14. The fishing garment of claim 10 wherein the size of the magnet is not less than 2 mm in diameter.

15. The fishing garment of claim 10 wherein the shape of the magnet is circular, oval, square, rectangular, polygonal, or, irregular.

16. The fishing garment of claim 10 wherein the shape of the magnet corresponds to letters, numbers, or groups of letters or numbers, or a logo, message, or slogan.

17. The fishing garment of claim 10 wherein the surface of the magnet is covered with a layer of material not greater than 1 mm thick.

18. The fishing garment of claim 10 wherein the garment is selected from the group consisting of Boonie hats, baseball caps, and hardhats, vests, life vests, shirts, T-shirts, polo shirts, sweatshirts, pullovers, sweaters, jackets, windbreakers, belts, suspenders, and pants.
